(19) United States
(12) Patent Application Publication
(10) Pub. No.: US 2010/0257857 A1
(43) Pub. Date: Oct. 14, 2010

(54) STIRLING ENGINE

(76) Inventors: Hiroshi Yaguchi, Susono-shi (JP); Daisaku Sawada, Gotemba-shi (JP); Masaaki Katayama, Susono-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/756,321

(22) Filed: Apr. 8, 2010

(30) Foreign Application Priority Data
Apr. 9, 2009 (JP) 2009-095350

(51) Int. Cl. F02G 1/044

(52) U.S. Cl. 60/517

(57) ABSTRACT

A Stirling engine includes a plurality of α-type Stirling cycle mechanisms, each of which includes a first piston and a second piston and pressurizes a crankcase space. The mechanisms are coupled to each other via a common rotary shaft so that each of the mechanisms generates a torque variation waveform in which the number of periods per rotation is two.

### INCORPORATION BY REFERENCE

The disclosure of Japanese Patent Application No. 2009-095350 filed on Apr. 9, 2009, including the specification, drawings and abstract is incorporated herein by reference in its entirety.

### BACKGROUND OF THE INVENTION

1. Field of the Invention

The invention relates to a Stirling engine and, more particularly, to a Stirling engine that includes a plurality of crankcase pressurizing α-type Stirling cycle mechanisms.

2. Description of the Related Art

In order to recover exhaust heat of an internal combustion engine mounted on a vehicle, such as an automobile, a bus and a truck, or exhaust heat from a factory, a Stirling engine that is excellent in theoretical thermal efficiency receives attention. A Stirling engine is expected to exhibit high thermal efficiency and is an external combustion engine that externally heats working fluid, so the Stirling engine is advantageous in that it can use various low temperature difference alternative energies, such as solar, geothermal heat and exhaust heat, irrespective of a heat source, and is useful for energy savings.

Japanese Patent Application Publication No. 2005-54640 (JP-A-2005-54640), Japanese Patent Application Publication No. 2008-223555 (JP-A-2008-223555) and Japanese Patent Application Publication No. 2006-118406 (JP-A-2006-118406), for example, describe such a Stirling engine that includes a plurality of Stirling-cycle mechanisms coupled to each other via a common rotary shaft. JP-A-2005-54640 describes that the same rotational phase difference (for example, 90°) is set between cylinders in the same Stirling cycle mechanism, while a selected rotational phase difference may be set between the Stirling cycle mechanisms. Other than the above, Japanese Patent Application Publication No. 2005-351242 (JP-A-2005-351242) and Japanese Patent Application Publication No. 2005-351243 (JP-A-2005-351243), for example, describe a crankcase pressurizing α-type Stirling engine.

Incidentally, in an α-type Stirling cycle mechanism, the amplitude of in-cylinder pressure is large as compared with a net work. Therefore, the α-type Stirling cycle mechanism has a characteristic that variations in output torque are large. Thus, in a Stirling engine that includes an α-type Stirling cycle mechanism, not only when the number of the mechanisms is one but also when the number of the mechanisms is multiple, it is necessary to sufficiently consider variations in output torque and suppress the variations. Note that it is conceivable that, for example, a flywheel or a damper is used to suppress variations in output torque. However, in this case, there is a problem that the size or weight of the Stirling engine increases and, as a result, vehicle mountability deteriorates.

### SUMMARY OF THE INVENTION

The invention provides a Stirling engine that is able to desirably suppress variations in output torque when the Stirling engine includes a plurality of α-type Stirling cycle mechanisms coupled to each other via a common rotary shaft.

As aspect of the invention relates to a Stirling engine. The Stirling engine includes a plurality of α-type Stirling cycle mechanisms, each of which includes a first piston and a second piston and pressurizes a crankcase space. The mechanisms are coupled to each other via a common rotary shaft so that each of the mechanisms generates a torque variation waveform in which the number of periods per rotation is two.

With the Stirling engine according to the aspect of the invention, when the Stirling engine includes a plurality of α-type Stirling cycle mechanisms coupled to each other via a common rotary shaft, variations in output torque may be desirably suppressed.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a schematic view that shows a Stirling engine that includes a single α-type Stirling engine mechanism according to a first embodiment of the invention;

FIG. 2 is a schematic view that shows the schematic configuration of a piston-crank portion of the Stirling engine according to the first embodiment;

FIG. 3 is a graph that shows the state of a normal variation in in-cylinder pressure P of the Stirling engine according to the first embodiment;

FIG. 4 is a graph that shows an in-cylinder pressure P, a crankcase pressure Pcr and a working gas mean pressure Pm in an initial state before a crankcase of the Stirling engine is pressurized according to the first embodiment;

FIG. 5 is a graph that shows an in-cylinder pressure P, a crankcase pressure Pcr and a working gas mean pressure Pm after the crankcase of the Stirling engine is pressurized according to the first embodiment;

FIG. 6 is a graph that shows the torque variation waveform of the Stirling engine according to the first embodiment, and also shows the torque variation waveform of a Stirling engine according to a comparative embodiment;

FIG. 7 is a schematic view that shows a Stirling engine according to a second embodiment of the invention;

FIG. 8 is a schematic view that shows an alternative embodiment to the Stirling engine according to the second embodiment;

FIG. 9 is a graph for illustrating the concept of reducing variations in output torque when a plurality of α-type Stirling cycle mechanisms are provided;

FIG. 10 is a graph that shows the torque variation waveforms before and after the two Stirling engines according to the first embodiment are coupled to each other;

FIG. 11A and FIG. 11B are schematic views that shows a drive shaft for which a phase difference β is set at 90° in the Stirling engine according to the second embodiment, in which FIG. 11A shows the drive shaft as viewed in a direction in which a crank axis CL extends and FIG. 11B is a perspective view of the drive shaft;

FIG. 12A and FIG. 12B are views that show a drive shaft for which a phase difference β is set at 90° as an alternative embodiment to the drive shaft in the Stirling engine according to the second embodiment;

FIG. 13 is a schematic view that shows a Stirling engine according to a third embodiment of the invention;

FIG. 14 is a schematic view that shows an alternative embodiment to the Stirling engine according to the third embodiment of the invention;

FIG. 15 is a graph that shows the torque variation waveforms before and after the three Stirling engines according to the first embodiment are coupled to each other;

FIG. 16 is a view that shows a drive shaft for which phase differences β are set at 60° according to the third embodiment, and shows the drive shaft as viewed in a direction in which a crank axis extends;

FIG. 17 is a view that shows a drive shaft for which phase differences β are set at 120° as an alternative embodiment to the drive shaft in the Stirling engine according to the third embodiment, and shows the drive shaft as viewed in a direction in which a crank axis extends;

FIG. 18 is a graph that shows the torque variation waveforms before and after three Stirling engines according to the first embodiment are coupled to each other in the case of FIG. 17;

FIG. 19 is a schematic view that shows a Stirling engine according to a fourth embodiment of the invention;

FIG. 20 is a schematic view that shows an alternative embodiment to the Stirling engine according to the fourth embodiment of the invention;

FIG. 21 is a graph that shows the torque variation waveforms before and after four Stirling engines according to the first embodiment are coupled to each other;

FIG. 22 is a view that shows a drive shaft for which phase differences (3 are set at 90° in the Stirling engine according to the fourth embodiment, and shows the drive shaft as viewed in a direction in which a crank axis extends; and

FIG. 23 is a table that shows examples of combinations of phases of respective expansion pistons provided respectively for the Stirling engines when the four Stirling engines according to the first embodiment are coupled to each other.

### DETAILED DESCRIPTION OF EMBODIMENTS

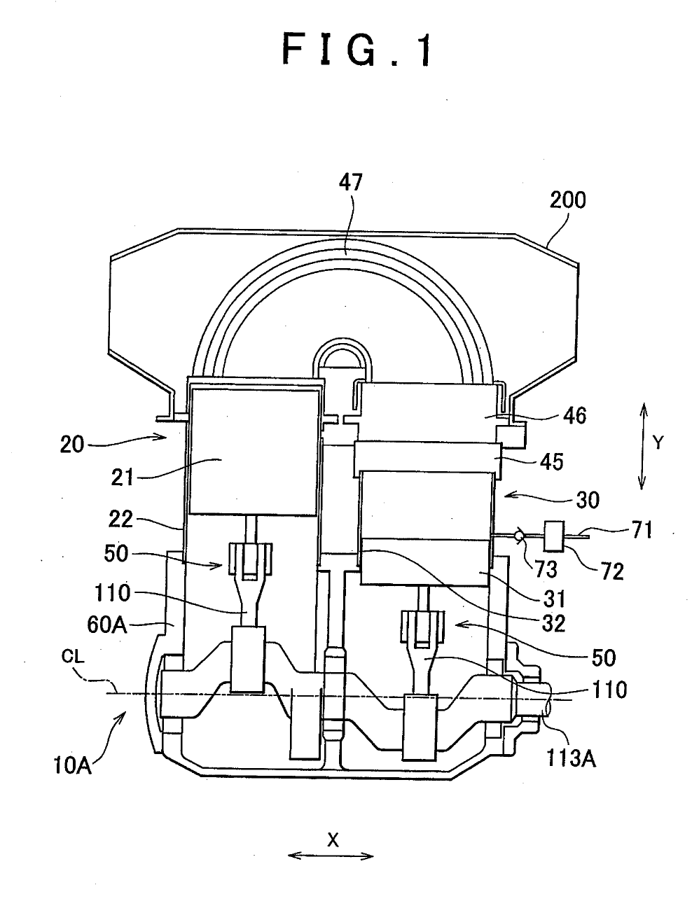

FIG. 1 is a schematic view that shows a Stirling engine 10A that includes a single α-type Stirling cycle mechanism according to a first embodiment of the invention. The Stirling engine 10A is a two-cylinder α-type Stirling engine. The Stirling engine 10A includes a high temperature-side cylinder 20 and a low temperature-side cylinder 30 that are arranged in series with each other so that a direction in which a crank axis CL extends is parallel to a cylinder arrangement direction X. Each of the cylinders 20 and 30 is fixed to a crankcase 60A. The high temperature-side cylinder 20 includes an expansion piston 21 and a high temperature cylinder 22. The expansion piston 21 corresponds to a first piston. The high temperature cylinder 22 corresponds to a first cylinder. The low temperature-side cylinder 30 includes a compression piston 31 and a low temperature cylinder 32. The compression piston 31 corresponds to a second piston. The low temperature cylinder 32 corresponds to a second cylinder. The compression piston 31 has a phase difference such that the compression piston 31 moves after a delay of about 90° in crank angle with respect to the expansion piston 21.

An upper space of the high temperature cylinder 22 is an expansion space. Working fluid heated by a heater 47 flows into the expansion space. Specifically, the heater 47 is arranged inside an exhaust pipe 200 of a gasoline engine mounted on a vehicle in the present embodiment. An upper space of the low temperature cylinder 32 is a compression space. Working fluid cooled by a cooler 45 flows into the compression space. A regenerator 46 exchanges heat with working fluid that reciprocally moves between the expansion space and the compression space. Specifically, the regenerator 46 receives heat from working fluid when the working fluid flows from the expansion space to the compression space, and radiates stored heat when working fluid flows from the compression space to the expansion space. The expansion space and the compression space constitute a working gas space. The crankcase 60A forms a crankcase space that is common to the high temperature-side cylinder 20 and the low temperature-side cylinder 30. The working gas space and the crankcase space are partitioned by the expansion piston 21 and the compression piston 31. Air is used as the working fluid. However, the working fluid is not limited to air; instead, gas, such as He, H₂ and N₂, may be, for example, used as the working fluid.

An introducing pipe 71 is provided as a working fluid introducing portion that introduces working fluid into the working gas space. In terms of this point, the introducing pipe 71 is specifically provided for the low temperature cylinder 32. The introducing pipe 71 provides fluid communication between the compression space of the low temperature cylinder 32 and the outside of the Stirling engine 10A. The introducing pipe 71 is provided with a filter 72 and a check valve 73. The filter 72 traps impurities. The check valve 73 allows circulation only in a direction from the outside toward the compression space, and transfers pressure.

Next, the operation of the Stirling engine 10A will be described. When working fluid is heated at the heater 47, the working fluid expands to press the expansion piston 21 downward. By so doing, a drive shaft (crankshaft) 113A is rotated. The drive shaft 113A that corresponds to a rotary shaft. Subsequently, when the expansion piston 21 enters the upstroke, working fluid passes by the heater 47 and is conveyed to the regenerator 46. Then, the working fluid radiates heat at the regenerator 46 and flows to the cooler 45. Working fluid cooled at the cooler 45 flows into the compression space, and further compressed with the upstroke of the compression piston 31. The working fluid compressed in this way then absorbs heat from the regenerator 46 to increase in temperature, and flows into the heater 47. Then, the working fluid is heated and expanded at the heater 47 again. That is, the Stirling engine 10A operates through reciprocal flow of the working fluid.

On the other hand, as reciprocal flow of working fluid occurs with reciprocation of the two pistons 21 and 31, the proportion of working fluid in the expansion space and working fluid in the compression space varies and the total internal volume also varies, so pressure variations occur. In terms of this point, when pressures are compared for each of the two pistons 21 and 31 at the same position, the pressure during downstroke is considerably higher than the pressure during upstroke in the case of the expansion piston 21; whereas the pressure during downstroke is lower than the pressure during upstroke in the case of the compression piston 31. Therefore, it is necessary that the expansion piston 21 does positive work (expansion work) to the outside and the compression piston 31 receives work (compression work) from the outside. Part of the expansion work is used for the compression work, and the remainder is extracted as output through the drive shaft 113A.

Incidentally, in the present embodiment, the heat source of the Stirling engine 10A is exhaust gas from the internal combustion engine of the vehicle, so the amount of heat obtained is restrictive, and it is necessary to operate the Stirling engine 10A within the range of the amount of heat obtained. Then, in the present embodiment, the internal friction of the Stirling engine 10A is reduced as much as possible. Specifically, in order to eliminate a friction loss due to a piston ring that gives the largest friction loss within the internal friction of the Stirling engine 10A, gas lubrication is performed between the cylinder 22 and the piston 21 and between the cylinder 32 and the piston 31.

In the gas lubrication, air pressure (distribution) occurs in a small clearance between the cylinder 22 and the piston 21 and a small clearance between the cylinder 32 and the piston 31 is utilized to float the pistons 21 and 31 in the air. Gas lubrication provides extremely small sliding resistance, so it is possible to greatly reduce the internal friction of the Stirling engine 10A. Specifically, the gas lubrication for floating an object in the air may be, for example, static pressure gas lubrication that jets pressurized fluid to generate static pressure to thereby float an object. However, the gas lubrication is not limited to the static pressure gas lubrication; it may be, for example, dynamic pressure gas lubrication.

Each of the clearances between the cylinder 22 and the piston 21 and between the cylinder 32 and the piston 31, for which gas lubrication is performed, is set at several tens of micrometers. Then, working fluid of the Stirling engine 10A is present in the clearances. The pistons 21 and 31 are respectively supported in a non-contact state with the cylinders 22 and 32 or in an allowable contact state through gas lubrication. Thus, no piston ring is provided around the piston 21 or 31, and no lubricating oil that is generally used together with a piston ring is used. In the gas lubrication, airtightness of each of the expansion space and the compression space is maintained by the small clearances to achieve clearance seal with no ring or oil.

Furthermore, both the pistons 21 and 31 and the cylinders 22 and 32 are made of metal, and, in the present embodiment, specifically, metal having the same coefficient of linear expansion (here, stainless steel) is used for the associated piston 21 and cylinder 22 and the associated piston 31 and the cylinder 32. By so doing, even when thermal expansion occurs, appropriate clearances may be maintained to perform gas lubrication. In addition, the pistons 21 and 31 and the cylinders 22 and 32 form the above small clearances to implement throttles that can ensure airtightness necessary for the working gas space while providing fluid communication between the working gas space and the crankcase space. In the Stirling engine 10A, the pistons 21 and 31 and the cylinders 22 and 32 correspond to a first communication portion.

Incidentally, in the case of gas lubrication, load capability is small, so the side forces of the pistons 21 and 31 should be substantially reduce to zero. That is, when gas lubrication is performed, withstanding capability (pressure resistant capability) against force in the diameter direction (lateral direction, thrust direction) of each of the cylinders 22 and 32 is low, so it is necessary that the accuracy of linear motion of each of the pistons 21 and 31 with respect to the axis of a corresponding one of the cylinders 22 and 32 is high.

Therefore, in the present embodiment, a grasshopper mechanism 50 is employed for each piston-crank portion. A mechanism for implementing linear motion includes not only the grasshopper mechanism 50 but also, for example, a Watt's mechanism. However, the grasshopper mechanism 50 may have a small-size mechanism necessary for obtaining the same accuracy of linear motion in comparison with another mechanism, so the grasshopper mechanism 50 has an advantageous effect that the device as a whole is compact. Particularly, the Stirling engine 10A according to the present embodiment is installed in a limited space, that is, an underfloor of an automobile, so the flexibility of installation increases when the device as a whole is compact. In addition, the grasshopper mechanism 50 has a characteristic that the weight of the mechanism necessary for obtaining the same accuracy of linear motion may be reduced as compared with another mechanism, so it is advantageous in terms of fuel economy. Furthermore, the configuration of the grasshopper mechanism 50 is relatively simple, so the grasshopper mechanism 50 is advantageous in that it is easy to construct (manufacture, assemble) the mechanism.

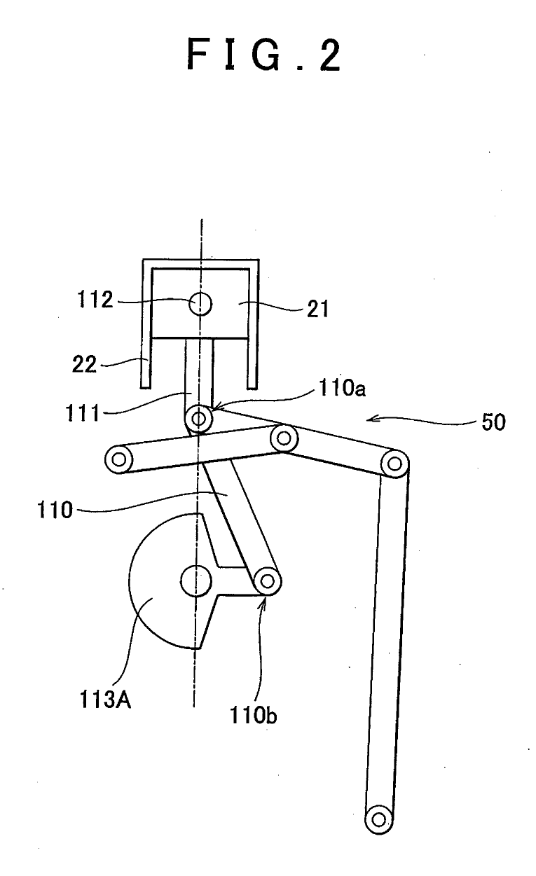

FIG. 2 is a schematic view that shows the schematic configuration of each piston-crank portion of the Stirling engine 10A. Note that the same configuration is employed for the piston-crank portion located at the side of the high temperature-side cylinder 20 and the piston-crank portion located at the side of the low temperature-side cylinder 30, so, in the following description, only the piston-crank portion located at the side of the high temperature-side cylinder 20 will be described, and the description of the piston-crank portion located at the side of the low temperature-side cylinder 30 is omitted. An approximate linear mechanism includes the grasshopper mechanism 50, a connecting rod 110, an extension rod 111 and a piston pin 112. The expansion piston 21 is connected to the drive shaft 113A via the connecting rod 110, the extension rod 111 and the piston pin 112. Specifically, the expansion piston 21 is connected to one end of the extension rod 111 via the piston pin 112. Then, a small end portion 110a of the connecting rod 110 is connected to the other end of the extension rod 111. Then, a large end portion 110b of the connecting rod 110 is connected to the drive shaft 113A.

The reciprocating motion of the expansion piston 21 is transmitted to the drive shaft 113A by the connecting rod 110, and is converted into the rotating motion by the drive shaft 113A. The connecting rod 110 is supported by the grasshopper mechanism 50, and linearly reciprocate the expansion piston 21. In this way, by supporting the connecting rod 110 by the grasshopper mechanism 50, the side force F of the expansion piston 21 becomes almost zero. Therefore, even when gas lubrication having small load capability is performed, it is possible to sufficiently support the expansion piston 21.

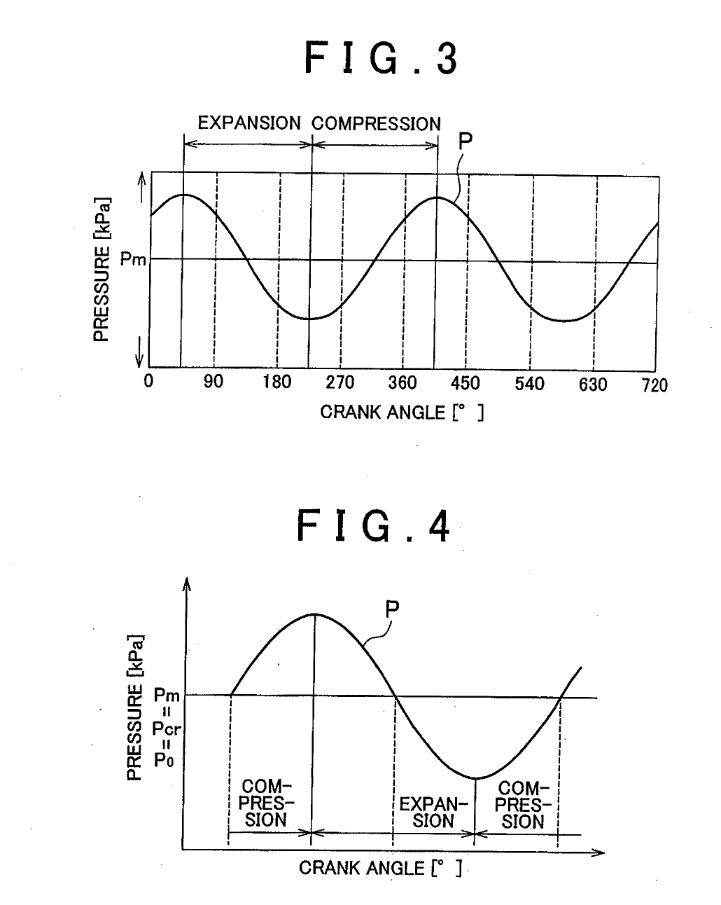

Incidentally, the Stirling engine 10A is a crankcase pressurizing Stirling engine. In terms of this point, the operation for pressurizing the crankcase space is as follows. Here, the in-cylinder pressure P, which is the pressure of working fluid, normally varies to repeatedly obtain a region lower than a working gas mean pressure Pm (from the latter half of expansion stoke to the first half of compression stroke) and a region higher than the working gas mean pressure Pm (from the latter half of compression stroke to the first half of expansion stroke) as shown in FIG. 3. Note that the working gas mean pressure Pm is a mean value of the in-cylinder pressure P per one cycle. In contrast, in the Stirling engine 10A, a variation in the in-cylinder pressure P is utilized to pressurize the crankcase space. Specifically, a variation in the in-cylinder pressure P is utilized to increase the working gas mean pressure Pm and also increase a crankcase pressure Pcr.

As shown in FIG. 4, in an initial state before the crankcase space is pressurized, the working gas mean pressure Pm and the crankcase pressure Pcr are equal to an atmospheric pressure Pₒ (for example, 100 kPa). Then, after the Stirling engine 10A is started, when the in-cylinder pressure P is lower than the atmospheric pressure Pₒ (from the latter half of expansion stroke to the first half of compression stroke), outside air at the atmospheric pressure Pₒ flows into the compression space via the introducing pipe 71. Then, outside air flowing into the compression space is pressurized in the compression stroke (particularly, from the latter half of the compression stroke) of the Stirling engine 10A. Furthermore, the pressure of the pressurized outside air is transmitted to the crankcase space via the small clearance between the cylinder 32 and the piston 31 and the small clearance between the cylinder 22 and the piston 21. By so doing, the crankcase space is pressurized. Then, when the above operation is repeated, the working gas mean pressure Pm becomes higher than the atmospheric pressure Pₒ, and the crankcase pressure Pcr becomes equal to the working gas mean pressure Pm.

In terms of this point, the pistons 21 and 31 and cylinders 22 and 32, which correspond to the first communication portion, have the function of balancing the pressure in the working gas space and the pressure in the crankcase space. Then, the introducing pipe 71, which corresponds to the working fluid introducing portion, and the pistons 21 and 31 and cylinders 22 and 32, which correspond to the first communication portion, serve as a pressurization enabling portion that enables the crankcase space to be pressurized so that the crankcase pressure Pcr is equal to the working gas mean pressure Pm. Note that, instead of providing the pressurization enabling portion, it is also applicable that the crankcase pressure Pcr becomes equal to the working gas mean pressure Pm by hermetically sealing high-pressure gas in the Stirling engine 10A in a state where the pistons 21 and 31 and cylinders 22 and 32, which correspond to the first communication portion, are provided. Specifically, the Stirling engine 10A has an α-type Stirling cycle mechanism that includes the high temperature-side cylinder 20, the low temperature-side cylinder 30, the cooler 45, the regenerator 46, the heater 47, the crankcase 60A, the approximate linear mechanism, the introducing pipe 71, the filter 72 and the check valve 73.

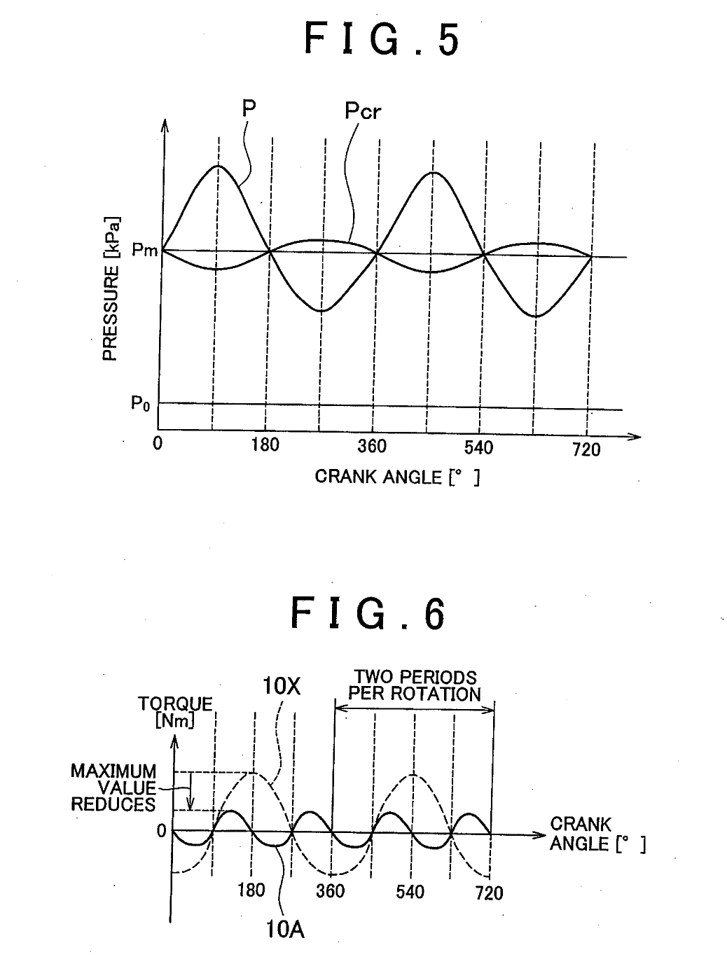

Next, the function and advantageous effects of the Stirling engine 10A will be described with reference to FIG. 5 and FIG. 6. In the Stirling engine 10A, the crankcase pressure Pcr is increased so that the crankcase pressure Pcr is equal to the working gas mean pressure Pm. Therefore, in the Stirling engine 10A, the magnitude relation between the in-cylinder pressure P and the crankcase pressure Pcr changes (see FIG. 5), and then the direction of output torque changes accordingly. Therefore, the frequency of torque variation waveform of the Stirling engine 10A is twice as large as that of a Stirling engine 10X according to a comparative embodiment in which the crankcase space is not pressurized as shown in FIG. 6. The crankcase pressurizing Stirling engine 10A provides the introducing pipe 71, the filter 72 and the check valve 73 compared with the Stirling engine 10X. Airtight between the working space and the crankcase space of the Stirling engine 10A is better than that of the Stirling engine 10X. The Stirling engine 10X is substantially the same as the Stirling engine 10A except that the introducing pipe 71, the filter 72 and the check valve 73 are not provided. Thus, the Stirling engine 10A generates a torque variation waveform in which the number of periods per rotation is two.

In addition, in the case of the Stirling engine 10X that does not pressurize the crankcase space, the pistons 21 and 31 each carry a pressure difference between the in-cylinder pressure P and the atmospheric pressure Pₒ as pressure loading (see FIG. 5). In contrast, in the Stirling engine 10A, the pistons 21 and 31 each carry only a pressure difference between the in-cylinder pressure P and the crankcase pressure Pcr as pressure loading (see FIG. 5). Thus, in the Stirling engine 10A, as a result, the maximum value of output torque variation reduces as shown in FIG. 6. Then, as a result, in the Stirling engine 10A, variations in output torque become small. That is, the Stirling engine 10A generates a torque variation waveform in which the number of periods per rotation is two, so variations in output torque may be desirably suppressed.

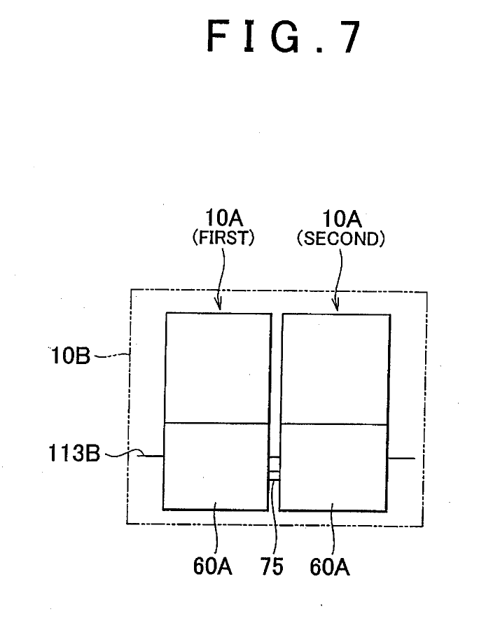

A Stirling engine 10B according to a second embodiment will be described with reference to FIG. 7. The Stirling engine 10B includes two Stirling engines 10A and a communication pipe 75 that corresponds to a second communication portion. That is, the Stirling engine 10B includes two α-type Stirling cycle mechanisms for which a phase difference between the expansion piston 21 and the compression piston 31 is set at the same phase difference (specifically, about 90°). The Stirling engines 10A (in other words, α-type Stirling cycle mechanisms) are coupled to each other via a common drive shaft 113B. The drive shaft 113B is formed so that the two drive shafts 113A are coupled to each other and structurally integrated.

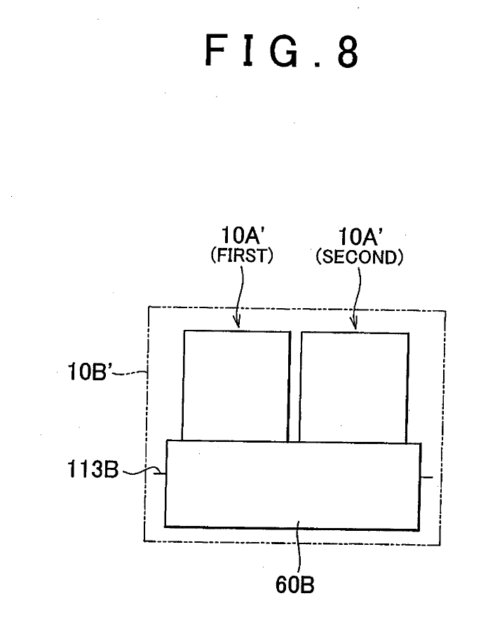

The communication pipe 75 provides fluid communication between the crankcase spaces of the respective Stirling engines 10A. In terms of this point, instead of providing the communication pipe 75, the Stirling engine 10B may be configured like a Stirling engine 10B′ in which, for example, as shown in FIG. 8, the crankcases 60A of the two α-type Stirling cycle mechanisms are modified into a single crankcase 60B that forms a crankcase space common to these mechanisms. Note that Stirling engines 10A′ that have the common crankcase 60B respectively correspond to the Stirling engines 10A of the Stirling engine 10B.

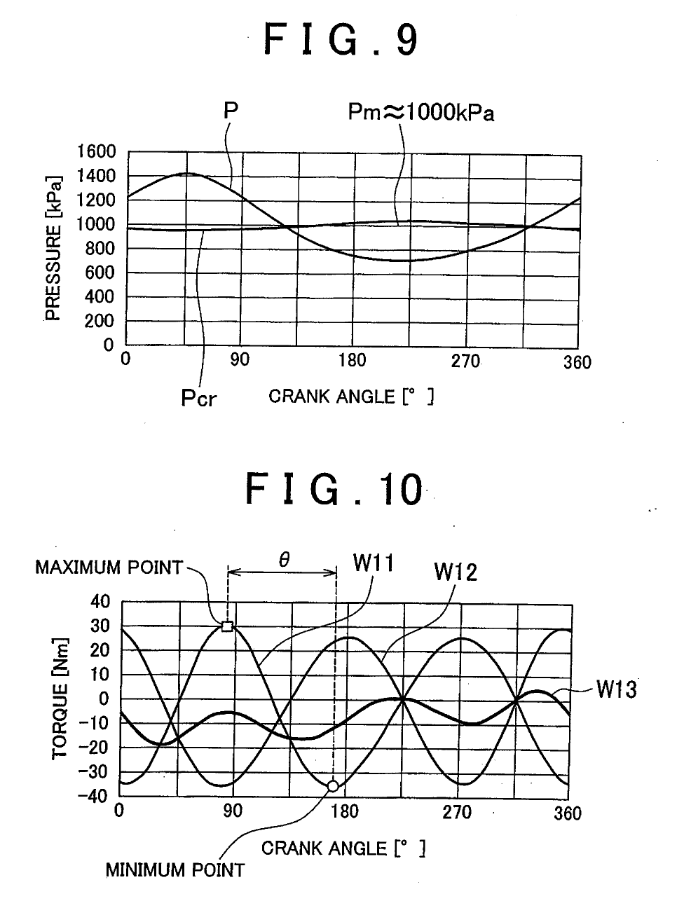

Next, the concept of reducing variations in output torque when the plurality of α-type Stirling cycle mechanisms are provided will be described with reference to FIG. 9. Here, when the plurality of α-type Stirling cycle mechanisms are provided, it is assumed that, as shown in FIG. 9, the top dead center (TDC) of the expansion piston 21 of each of the mechanisms is set at a phase of 0° and the in-cylinder pressure becomes maximum at 45°. In addition, the in-cylinder pressure P that greatly varies as shown in FIG. 9 predominantly influences output torque, so only variations in output torque generated because of the influence of the in-cylinder pressure P are considered. Then, on the above assumption, a phase difference is set between the mechanisms, and a synthesized waveform of torque variation waveforms of the respective mechanisms, which is able to suppress variations in output torque, is generated.

In the Stirling engine 10B, on the basis of the above concept, specifically, as described as follows, a phase difference β between the Stirling engines 10A (in other words, α-type Stirling cycle mechanisms) is set. Specifically, the phase difference β is a phase difference between the expansion pistons 21 (or, in other words, the compression pistons 31) of the adjacent Stirling engines 10A.

FIG. 10 is a graph that shows torque variation waveforms before and after the two Stirling engines 10A are coupled to each other. Before the Stirling engines 10A are coupled to each other, the torque variation waveform of the first Stirling engine 10A is a waveform W11. In addition, the torque variation waveform of the second Stirling engine 10A is a waveform W12. Then, when the Stirling engines 10A are coupled to each other, in the Stirling engine 10B, the phase difference 6 is set so as to be substantially equal to an angular difference 6 between the maximum point and the minimum point that are adjacent to each other in the waveform W11, which is one of the torque variation waveforms of the Stirling engines 10A.

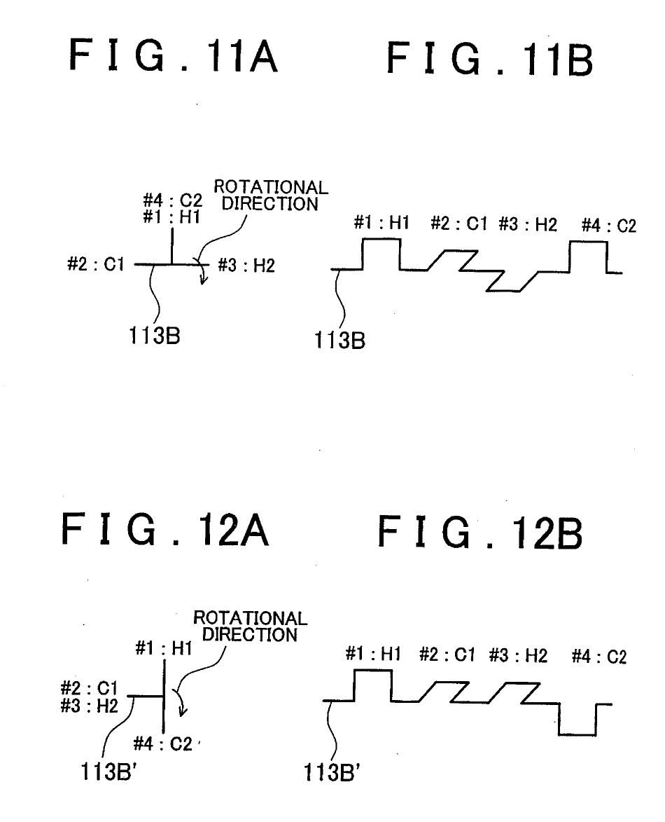

In terms of this point, in the waveforms W11 and W12, which are the torque variation waveforms of the Stirling engines 10A, specifically, the maximum point and the minimum point are present alternately at an interval of about 90°. Therefore, in the Stirling engine 10B, the phase difference β is further specifically set at 90°. On the other hand, the phase difference β is set using the drive shaft 113B. In terms of this point, specifically, in the Stirling engine 10B, as shown in FIG. 11A and FIG. 11B, in the Stirling engines 10A, the phase difference β is set so that the phase of the second expansion piston 21 (#3H2) is advanced by 90° from the phase of the first expansion piston 21 (#1H1). Note that the relationship in phase between the compression pistons 31 of the Stirling engines 10A is the same as that between the expansion pistons 21. Note that, in FIG. 11A and FIG. 11B, # and the suffix numbers denote cylinder numbers that are assigned in consecutive numbers to all the cylinders 20 and 30 of each of the Stirling engines 10A, H denotes the expansion piston 21, C denotes the compression piston 31 and numbers suffixed to H or C denote the sequence of the Stirling engine 10A (which Stirling engine 10A).

Next, the function and advantageous effects of the Stirling engine 10B will be described. In the Stirling engine 10B, the phase difference β is set as described above, so the waveforms W11 and W12 are synthesized to desirably cancel each other. Then, as a result, the torque variation waveform of the Stirling engine 10B becomes a waveform W13 of which variations in output torque are desirably suppressed by synthesizing the waveforms W11 and W12 as shown in FIG. 10. That is, with the Stirling engine 10B, when the plurality of Stirling engines 10A, each of which generates a torque variation waveform in which the number of periods per rotation is two to suppress variations in output torque, are coupled to each other, the waveforms W11 and W12 are synthesized, so variations in output torque of the Stirling engine 10B as a whole may be desirably suppressed.

In addition, in the Stirling engine 10B, the communication pipe 75 provides fluid communication between the crankcase spaces of the respective Stirling engines 10A. Therefore, in the Stirling engine 10B, the working gas mean pressure Pm may be equal between the Stirling engines 10A. By so doing, in the Stirling engine 10B, in the Stirling engines 10A, pressure loadings applied to the pistons 21 and 31 may be equal to each other. In addition, by so doing, in the Stirling engine 10B, the shapes of the torque variation waveforms of the Stirling engines 10A may be similar to each other. Thus, the Stirling engine 10B is able to desirably suppress variations in output torque as described above.

Note that, to set the phase difference β at 90°, for example, it may be set as follows. That is, for example, as shown in FIG. 12A and FIG. 12B, in the Stirling engines 10A, the phase difference β may be set so that the phase of the second expansion piston 21 (#3H2) is delayed by 90° from the phase of the first expansion piston 21 (#1H1). The thus set phase difference β may be specifically implemented by providing a drive shaft 113B′ for which the phase difference β is set; instead of the drive shaft 113B. Note that FIG. 12A and FIG. 12B show the drive shaft 113B′ like FIG. 11A and FIG. 11B. In addition, the meanings of symbols, such, as #, are also similar to those of FIG. 11A and FIG. 11B.

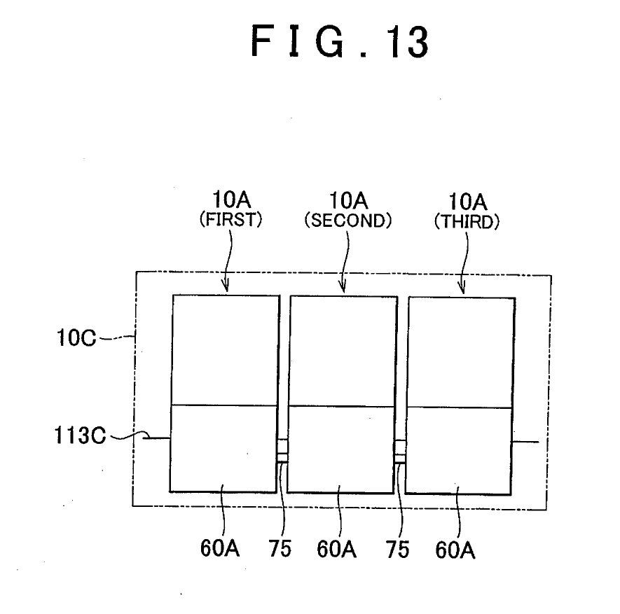

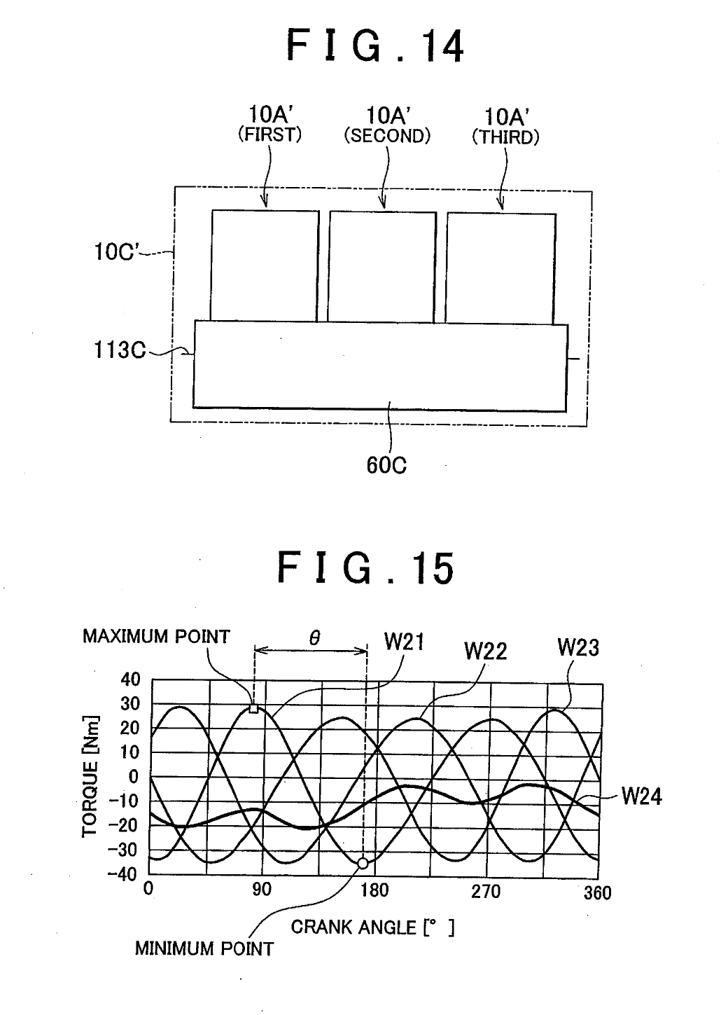

A Stirling engine 10C according to a third embodiment will be described with reference to FIG. 13. The Stirling engine 10C includes three Stirling engines 10A and two communication pipes 75. The Stirling engines 10A (in other words, α-type Stirling cycle mechanisms) are coupled to each other via a common drive shaft 113C. The drive shaft 113C is formed so that three drive shafts 113A are coupled to each other and structurally integrated. Each communication pipe 75 provides fluid communication between the crankcase spaces of the adjacent Stirling engines 10A. In terms of this point, instead of providing the communication pipes 75, the Stirling engine 10C may be configured as a Stirling engine 10C in which, for example, as shown in FIG. 14, the crankcases 60A of the three α-type Stirling cycle mechanisms are modified into a single crankcase 60C that forms a crankcase space common to these mechanisms.

In the Stirling engine 10C, phase differences 13 are set as follows. FIG. 15 is a graph that shows the torque variation waveforms before and after the three Stirling engines 10A are coupled to each other. In FIG. 15, the torque variation waveforms of the first, second and third Stirling engines 10A before being coupled to each other are waveforms W21, W22 and W23, respectively. Then, to couple the Stirling engines 10A, in the Stirling engine 10C, the phase differences β each are set so as to be about two thirds (2/3) of the angular difference θ.

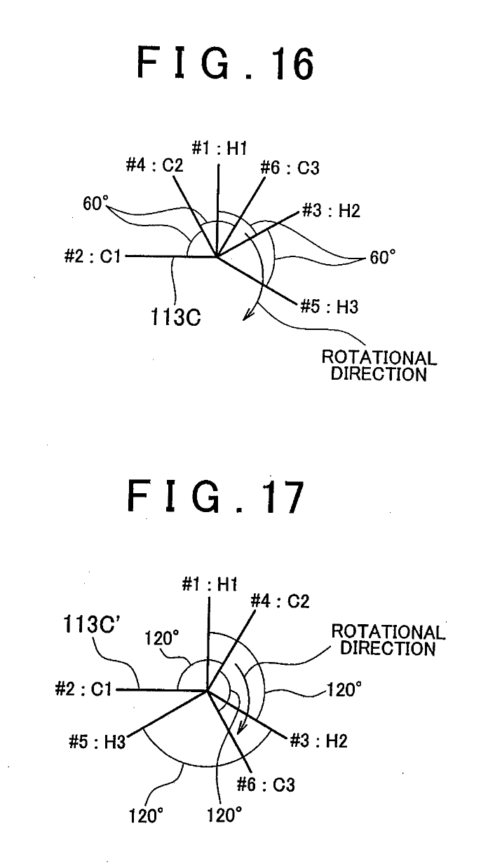

In terms of this point, in the waveforms W21, W22 and W23, which are the torque variation waveforms of the Stirling engines 10A, specifically, the maximum point and the minimum point are present alternately at an interval of about 90°. Therefore, further specifically, in the Stirling engine 10C, the phase differences β each are set at 60°. On the other hand, the phase differences β are set using the drive shaft 113C. In terms of this point, specifically, in the Stirling engine 10C, as shown in FIG. 16, in the Stirling engines 10A, the phase differences β are set so that the phase of the second expansion piston 21 (#3H2) is advanced by 60° from the phase of the first expansion piston 21 (#1H1). In addition, the phase differences β are set so that the phase of the third expansion piston 21 (#5H3) is advanced by 60° from the phase of the second expansion piston 21 (#3H2). Note that, in FIG. 16, the meanings of symbols, such as #, are also similar to those of FIG. 11A and FIG. 11B.

Next, the function and advantageous effects of the Stirling engine 10C will be described. In the Stirling engine 10C, the phase differences β are set as described above, so the waveforms W21, W22 and W23 are synthesized to desirably cancel each other. Then, as a result, the torque variation waveform of the Stirling engine 10C becomes a waveform W24 of which variations in output torque are desirably suppressed by synthesizing the waveforms W21, W22 and W23 as shown in FIG. 15. Therefore, with the Stirling engine 10C, when the three Stirling engines 10A are coupled to each other via the common drive shaft 113C, variations in output torque may be desirably suppressed. In addition, in the Stirling engine 10C, each communication pipe 75 provides fluid communication between the crankcase spaces of the adjacent Stirling engines 10A. Therefore, the Stirling engine 10C, as well as the Stirling engine 10B, is able to desirably suppress variations in output torque as described above.

Note that, when the three Stirling engines 10A are coupled to each other, the phase differences β each may be set so as to be about four thirds (4/3) of the angular difference θ. That is, the phase differences β may be set at 120°. In this case, for example, as shown in FIG. 17, in the Stirling engines 10A, the phase differences β may be set so that the phase of the second expansion piston 21 (#3142) is advanced by 120° from the phase of the first expansion piston 21 (#1H1). In addition, the phase differences β may be set so that the phase of the third expansion piston 21 (#5H3) is advanced by 120° from the phase of the second expansion piston 21 (#3H2). The thus set phase differences β may be specifically implemented by providing a drive shaft 113C′ for which the phase differences β are set, instead of the drive shaft 113C. Note that, in FIG. 17, the meanings of symbols, such as #, are also similar to those of FIG. 11A and FIG. 11B.

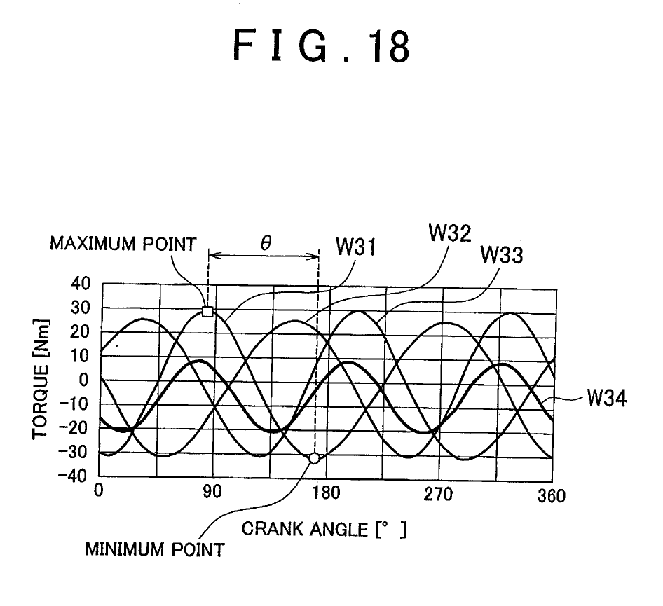

On the other hand, when the drive shaft 113C′ is provided instead of the drive shaft 113C, the torque variation waveforms before and after the three Stirling engines 10A are coupled to each other are those shown in FIG. 18. Then, in this case, as a result of the torque variation waveforms W31, W32 and W33 of the Stirling engines 10A, which are synthesized to cancel each other, the torque variation waveform after being coupled to each other becomes a waveform W34. In this case, variations in output torque are larger than those when the drive shaft 113C is provided; however, variations in output torque may be desirably suppressed in this case as well.

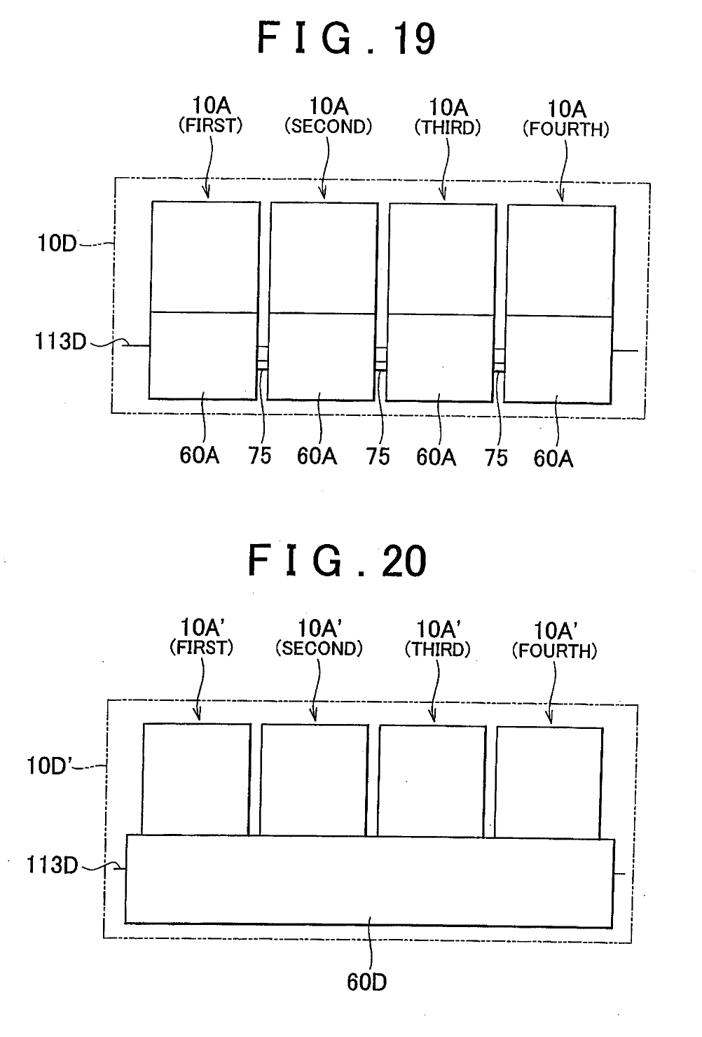

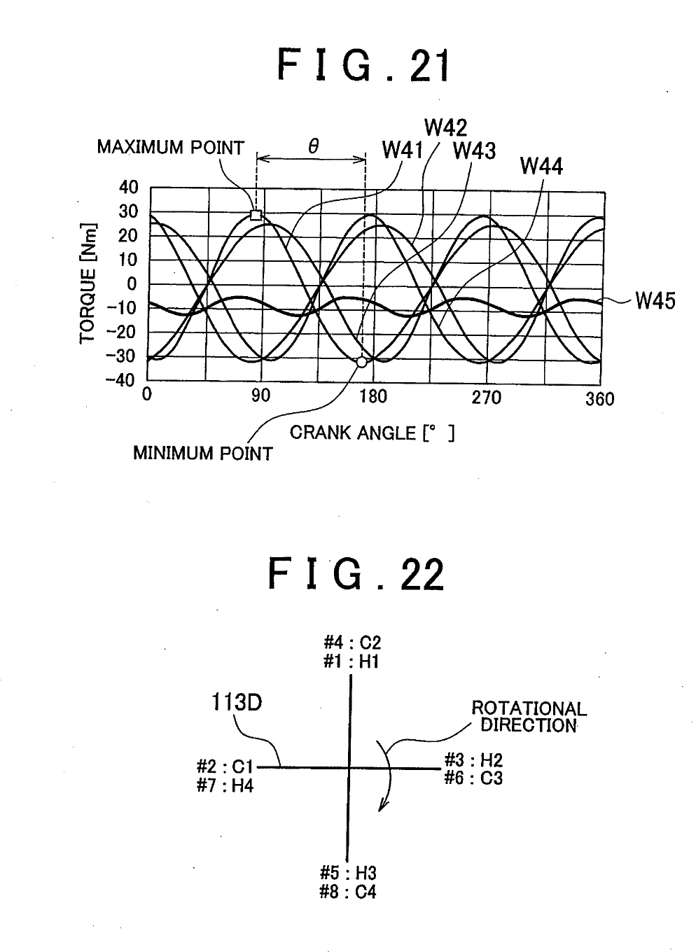

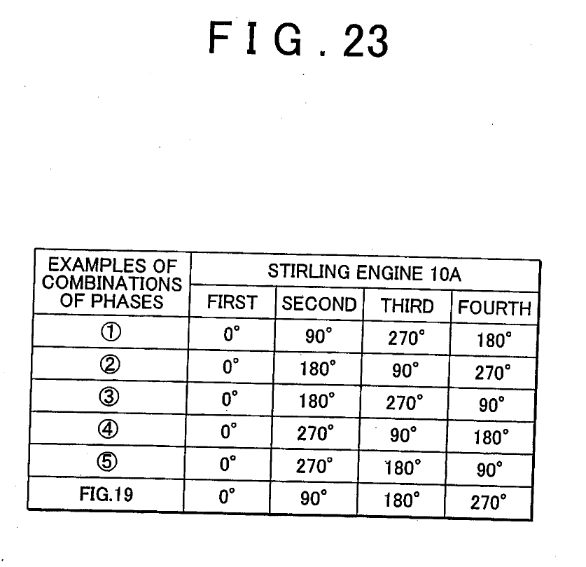

A Stirling engine 10D according to a fourth embodiment will be described with reference to FIG. 19. The Stirling engine 10D includes four Stirling engines 10A and three communication pipes 75. The Stirling engines 10A (in other words, α-type Stirling cycle mechanisms) are coupled to each other via a common drive shaft 113D. The drive shaft 113D is formed so that four drive shafts 113A are coupled to each other and structurally integrated. Each communication pipe 75 provides fluid communication between the crankcase spaces of the adjacent Stirling engines 10A. In terms of this point, instead of providing the communication pipes 75, the Stirling engine 10D may be configured as a Stirling engine 10D′ in which, for example, as shown in FIG. 20, the crankcases 60A of the four α-type Stirling cycle mechanisms are modified into a single crankcase 60D that forms a crankcase space common to these mechanisms.

In the Stirling engine 10D, the phase differences β are set as follows. FIG. 21 is a graph that shows the torque variation waveforms before and after the four Stirling engines 10A are coupled to each other. In FIG. 21, the torque variation waveforms of the first, second, third and fourth Stirling engines 10A before being coupled to each other are waveforms W41, W42, W43 and W44, respectively.

Then, when the Stirling engines 10A are coupled to each other, in the Stirling engine 10D, the phase differences β are set so as to be substantially equal to multiples of the angular difference θ. In addition, in the Stirling engine 10D, the phase differences β are set so that the phases of the expansion pistons 21 (in other words, the compression pistons 31) of the respective Stirling engines 10A do not overlap each other. In addition, in the torque variation waveforms W41, W42, W43 and W44 of the Stirling engines 10A, specifically, the maximum point and the minimum point are present alternately at an interval of about 90°. In terms of this point, more specifically, in the Stirling engine 10D, the phase differences β are set at 90°.

On the other hand, the phase differences β are set using the drive shaft 113D. In terms of this point, specifically, in the Stirling engine 10D, as shown in FIG. 22, in the Stirling engines 10A, the phase differences β are set so that the phase of the second expansion piston 21 (#3H2) is advanced by 90° from the phase of the first expansion piston 21 (#1H1). In addition, the phase differences β are set so that the phase of the third expansion piston 21 (#5H3) is advanced by 90° from the phase of the second expansion piston 21 (#3H2), and the phase differences β are set so that the phase of the fourth expansion piston 21 (#7H4) is advanced by 90° from the phase of the third expansion piston 21 (#5H3). Note that, in FIG. 22, the meanings of symbols, such as #, are also similar to those of FIG. 11A and FIG. 11B.

Next, the function and advantageous effects of the Stirling engine 10D will be described. In the Stirling engine 10D, the phase differences β are set as described above, so the waveforms W41, W42, W43 and W44 are synthesized to desirably cancel each other. Then, as a result, the torque variation waveform of the Stirling engine 10D becomes a waveform W45 of which variations in output torque are desirably suppressed by synthesizing the waveforms W41, W42, W43 and W44 as shown in FIG. 21. Therefore, with the Stirling engine 10D, when the four Stirling engines 10A are coupled to each other via the common drive shaft 113D, variations in output torque may be desirably suppressed. In addition, in the Stirling engine 10D, each communication pipe 75 provides fluid communication between the crankcase spaces of the adjacent Stirling engines 10A. Therefore, the Stirling engine 10D, as well as the Stirling engines 10B and 10C, is able to desirably suppress variations in output torque as described above.

Note that, when the four Stirling engines 10A are coupled to each other, the phase differences β may be set using a combination of 90° and 180°. FIG. 23 is a table that shows examples of combinations of phases of the respective expansion pistons 21 provided respectively for the Stirling engines 10A when the four Stirling engines 10A are coupled to each other. In these examples, the phase difference β of any one of 90° and 180° is set between the Stirling engines 10A. Then, even in any case, variations in output torque may be desirably suppressed as shown in FIG. 21.

In the above described embodiments, the drive shaft (for example, the drive shaft 113B) formed of the plurality of drive shafts 113A coupled to each other is a common rotary shaft. However, the aspect of the invention is not limited to this configuration; the rotary shaft may be formed of a single member.

In addition, in the above described third embodiment, in order to set the phase differences β at any one of 60° and 120°, the phases of the expansion piston 21 of the Stirling engines WA are advanced by 60° or 120° sequentially. However, the aspect of the invention is not limited to this configuration; for example, the phase differences β may be set at any one of 60° and 120° by delaying the phases of the expansion pistons 21 of the Stirling engines 10A by 60° or 120° sequentially.

In addition, in the above described embodiments, it is advantageous in pressurizing the crankcase spaces in terms of cost, or the like, so the introducing pipe 71 introduces outside air at the atmospheric pressure P0 into the working gas space as working fluid. However, the aspect of the invention is not limited to this configuration, the working fluid introducing portion may, for example, introduce working fluid, which is used in the Stirling engine and is other than outside air, into the working gas space or may introduce working fluid having a pressure higher than the atmospheric pressure into the working gas space.

In addition, in the above described embodiments, because of rationality in terms of configuration, and the like, the pistons 21 and 31 and cylinders 22 and 32, which form small clearances, serve as the first communication portion. However, the aspect of the invention is not limited to this configuration; the first communication portion may be, for example, a communication portion, such as a pipe, that has a throttle that is able to ensure airtightness necessary for the working gas space and that provides fluid communication between the working gas space and the crankcase space.

While the invention has been described with reference to example embodiments thereof, it is to be understood that the invention is not limited to the described embodiments or constructions. The invention is intended to cover various modifications and equivalent arrangements. In addition, while the various elements of the disclosed invention are shown in various example combinations and configurations, other combinations and configurations, including more, less or only a single element, are also within the scope of the appended claims.

What is claimed is:

1. A Stirling engine comprising:
a plurality of α-type Stirling cycle mechanisms, each of which includes a first piston and a second piston and pressurizes a crankcase space, wherein
the mechanisms are coupled to each other via a common rotary shaft so that each of the mechanisms generates a torque variation waveform in which the number of periods per rotation is two.

2. The Stirling engine according to claim 1, wherein
when the Stirling engine includes the two mechanisms, a phase difference between the first pistons of the respective mechanisms or a phase difference between the second pistons of the respective mechanisms is set at 90°.

3. The Stirling engine according to claim 1, wherein
when the Stirling engine includes the three mechanisms, phase differences between the first pistons of the respective mechanisms or phase differences between the second pistons of the respective mechanisms each are set at any one of 60° and 120°.

4. The Stirling engine according to claim 1, wherein
when the Stirling engine includes the four mechanisms, phase differences between the first pistons of the respective mechanisms or phase differences between the second pistons of the respective mechanisms are set at 90° or a combination of 90° and 180° so that phases of the first pistons of the respective mechanisms or phases of the second pistons of the respective mechanisms do not overlap each other.

5. The Stirling engine according to claim 1, further comprising:
a first communication portion that provides fluid communication via a throttle between a working gas space, in which working fluid is contained, and a crankcase space in each of the mechanisms, wherein crankcases of the respective mechanisms are integrated as one crankcase that forms the crankcase space common to the mechanisms.

6. The Stirling engine according to claim 5, wherein
the first communication portion is formed of the first piston, the second piston, a first cylinder and a second cylinder, wherein the first cylinder and the second cylinder respectively form clearances with the first piston and the second piston.

7. The Stirling engine according to claim 5, wherein
the first communication portion is a pipe that provides fluid communication between the working gas space and the crankcase space.

8. The Stirling engine according to claim 6, wherein
gas lubrication is performed between the first piston and the first cylinder and between the second piston and the second cylinder.

9. The Stirling engine according to claim 8, wherein
the first piston and the second piston each are coupled to the rotary shaft via a grasshopper mechanism.
